(19) United States
(12) Patent Application Publication
(10) Pub. No.: US 2015/0207149 A1
(43) Pub. Date: Jul. 23, 2015

(54) ELECTRODE FOR A GALVANIC CELL

(71) Applicant: V-TRION GMBH, Hohenems (AT)

(72) Inventors: Thomas Froeis, Weiler (AT); Margit Lenninger, Egg (AT); Thomas Bechtold, Dornbirn (AT); Günter Grabher, Lustenau (AT); Jutta Hofer, Lustenau (AT); Markus Riedmann, Lustenau (AT)

(73) Assignee: V-TRION GMBH, Hohenems (AT)

(21) Appl. No.: 14/423,577

(22) PCT Filed: Aug. 23, 2013
(86) PCT No.: PCT/AT2013/050165

§ 371 Date: Feb. 24, 2015

(30) Foreign Application Priority Data
Aug. 24, 2012 (AT) A 50343/2012

(51) Int. Cl. H01M 4/66; H01M 4/74; H01M 4/88; H01G 11/24

(52) U.S. Cl. CPC H01M 4/667; H01G 11/24; H01M 4/661; H01M 4/663; H01M 4/747; H01M 4/8803

(57) ABSTRACT

An electrode for a galvanic cell, characterized by a carrier, which is provided with an embroidery, wherein at least a part of the surface of the embroidery is configured to be electrically conductive.

The invention relates to an electrode for an electrochemical cell having a surface structure as well as a galvanic cell and a half-cell, including an electrode.

The generation and storage of energy play a central role with mobile applications. In order meet the increasing demand of mobile energy generation and storage the focus is placed on the development of electrochemical processing techniques. Mobile energy generation and storage is accomplished for the most part by means of electrochemical or galvanic, respectively, cells. An electrochemical or galvanic cell is an energy storage device and an energy converter, which converts chemical energy (reaction enthalpy) into electrical energy and vice versa. These include, for example, batteries, accumulators, super-capacitors and fuel cells. All these energy storage systems have in common that they alternately transform electrical energy into energy-rich chemical substances and vice versa. This energy conversion is performed, depending on the construction of the electrochemical cell and the effectivity of the system, more or less completely.

In the development and dimensioning of electrochemical energy storage devices there are given different parameters, wherein these parameters subsequently also determine the possible applications of the electrochemical energy storage device. The following important parameters are to be taken into consideration:
Energy efficiency describes how much of the electrical energy used when charging the electrochemical energy storage device is recovered during discharging.
Coulometric efficiency describes the amount of charge that is effectively reversibly converted into chemical storage substances.
Energy storage capacity (kWh) describes the energy that may be stored at the maximum in the electrochemical energy storage device by means of chemical conversion, which is defined by the amounts of chemicals present in an accumulator/a battery and by the cell voltage of the system used.
Actually usable energy is pre-set by the actually achievable level of chemical conversion during charge/discharge under the operable conditions. It is in general significantly lower than the value calculated in theory. Under practical conditions this means that in many batteries and accumulators the energetic utilization of the chemicals present is only incomplete.
Energy density (Wh/kg) describes the amount of energy that may be stored per kg weight of the cell. This value is with batteries/accumulators with, e.g., 200 Wh/kg relatively high, but it is still significantly lower than the theoretically calculated values (Claus Daniel and Jürgen O. Besenhard, Handbook of Battery Materials, Vol 1 and 2, Wiley-VCH, 2011, ISBN 978-3-527-32695-2).
Performance density (W/kg) gives the maximal electrical performance that may be discharged per kg weight of the cell. Typical values for batteries/accumulators with 10 to 100 W/kg are significantly below the performances of super-capacitors, which may store between 10³ to 10⁶ W/kg. Such super-capacitors, however, achieve only a rather low energy density of 0.01-0.1 Wh/kg (T. Nguyen, R. F. Savinell, Flow Batteries, The Electrochemical Society Interface, Fall 2010, 54-55).

The extraordinarily high performance density of the super-capacitors is a result of the fact that the electrochemical storage of charge is realized only at a very thin interface to the electrolyte and thus provides for very quick charging/discharging. The low thickness of the layer in this way conditions also low energy density, which prevents the use thereof for longer energy storage.

The higher energy density of the accumulators and batteries is achieved by using appropriately large quantities of active masses. In order to realize electrochemical conversions, the active masses have to have porous structures and have to be simultaneously brought into electrical contact with the discharge electrode. A thicker active layer increases the storage capacity of a construction, with the electrical conductivity, however, being limited by the porous structure, entailing several disadvantages: the cells have a relative high internal resistance, i.e. in the case of high current densities, the cell voltage and, hence, the level of efficiency will decrease. The utilization of the active mass is realized only in part, so that the effectively usable energy density is decreased. Charging of the accumulator is limited by the maximal introducible current density, which in turn is limited by the current transition from the discharge electrode to the active mass.

The limited conductivity of the different active masses has the consequence that many cell concepts use only thin layers, consequently have to have high surface areas at the discharge electrodes and thus gain additional undesired weight. In many accumulator concepts the chemical conversions also lead to dimensional changes in the active electrode mass during charging/discharging, which increases mechanical sensitivity and is disadvantageous for current transmission. Stripped off parts of the electrode filler mass may, e.g., with lead accumulators, result in internal short circuits and failure of the element.

A possibility to combine the advantages of the higher energy density of the batteries/accumulators with the higher performance density of the super-capacitors lies in the use of three-dimensional electrode structures, which improve current supply and current discharge into the depth of the active mass. According to prior art, there have been described most varied concepts for the integration of conductive structures in electrochemical active masses of accumulators/batteries.

U.S. Pat. No. 4,250,235 discloses a nickel metal mesh produced by etching as a conductive support for the active mass in a NiH battery. In U.S. Pat. No. 3,441,390 there is shown the use of a nickel powder and of nickel metal fibres for the production of an electrode. U.S. Pat. No. 3,960,601 discloses the use of carbon fibres for the production of a conductive electrode structure. According to U.S. Pat. No. 4,731,311 there is produced a conductive porous sponge structure by means of polymerization of the respective starting materials as an electrode coating. The use of expanded metal constructions in electrolysis cells was shown in DE 10 2004 023 161 A1.

The concepts described in prior art increase conductivity in the porous structure. The current supply, however, is always realized from the backside of the electric cell, which, in turn, limits current density achievable in total or the cell current, respectively, depending on the porosity of the mass, the conductivity of the current conducting materials and the conductivity of the electrolyte. Although the solutions proposed according to prior art, hence, improve behaviour in proportionally thin layers, they are, however, of only limited value as soon as the active mass reaches a thickness of several mm.

In the literature there was also described the use of textile materials (non-woven materials, fabrics) as current dividers. In U.S. Pat. No. 5,242,768 there are described three-dimensional fabrics for the production of conductive electrode structures. According to DE 195 06 496 and DE 197 20 792 three-dimensional mesh-like metal structures as electrodes are separated by non-conductive elements. The disadvantages of these concepts are the result of several aspects: the materials are to be adapted to the cell dimension by cutting, causing material waste, increased costs and technical problems at the cutting edges.

The contacting of the materials and the electric transition to the discharge electrode as well as guaranteeing of a uniform current distribution result in additional expenditure. In a well-known embodiment of electrolysis cells having three-dimensional electrodes for electrolytes with lower current densities according to WO 95/07374 A1 several electrode elements made of stainless steel fabrics are supplied separately with current and combined in the same electrolyte into a common electrode. Such multi-cathodes or multi-electrode cells, respectively, achieve substantially higher electrode areas in comparison with plate-like constructions. The high technical efforts for the production of such multi-electrode constructions has limited the use thereof to specific examples of use.

Hence, it is the objective of the present invention to provide a galvanic cell, wherein the problems mentioned are reduced. In particular, the galvanic cell is to guarantee an optimized current distribution at the same time with high energy density and high performance density. In particular, there is to be provided for that the active mass may have a thickness of several mm.

This task is solved by an electrode for a galvanic cell, characterized by a carrier, which is provided with an embroidery, wherein at least a region of the surface of the embroidery is configured to be electrically conductive.

In simple terms, it is an embroidered electrode for electrochemical processes, wherein an electrically conductive material is attached to a carrier material by way of embroidering technique so that there is formed a three-dimensional, electrically conductive structure. In this way, the electrode may have an active mass of several mm thickness in a galvanic cell, wherein optimized current distribution and high energy density as well as performance density are possible.

Accordingly, the task is solved by a galvanic cell including two electrodes, which are each embedded in an electrolyte, wherein at least one electrode is characterized by a carrier material, which is provided with an embroidery, wherein at least a region of the surface of the embroidery is configured to be electrically conductive. The task is further solved by a half-cell including an electrode, which is embedded in an electrolyte, wherein the electrode is characterized by a carrier material, which is provided with an embroidery, wherein at least a region of the surface of the embroidery is configured to be electrically conductive.

In the following embodiments and advantageous variants are described, which are true for the electrode alone as well as for the galvanic cell and the half-cell.

In one embodiment variant it has proven to be advantageous if there are present at least two different carrier types. Different carrier types include, on the one side, carriers of the same structure but of different materials, of the same materials and of different structure or of different materials and of different structure. For the functioning of the invention, however, an individual carrier type is sufficient.

In regard to the structure there may be mentioned, for example, that the carrier has a non-woven fabric, a film, a fabric, a mesh or a mixture thereof.

In regard to the materials, there may, one the one side, be semi-qualitatively distinguished between electrical conductors and electrical non-conductors and, on the other side, qualitatively between the actual materials. For the latter, there may be mentioned plastic materials, textiles, metals and so on, for example.

Accordingly, this gives rise to different embodiment variants. On the one side, the carrier may be configured to be at least in part electrically insulating, on the other side, the carrier may be configured to be at least in part electrically conductive. Finally, at least one carrier type may be configured to be at least in part electrically conductive and at least one carrier type may be configured to be electrically insulating. As the electrode is present in a galvanic cell embedded in an electrolyte, there is preferably provided that the surface of the carrier is configured to be at least in part electrically insulating or that the surface of the carrier is configured to be at least in part electrically conductive or that the surface of one carrier type is configured to be at least in part electrically conductive and of at least one carrier type is configured to be electrically insulating.

In regard to the carrier there may further be provided that the carrier has a basic structure and a coating applied at least to regions of the basic structure. The coating is preferably an electrically conductive coating.

In one embodiment variant there is provided that the carrier and the embroidery are provided with an electrically conductive coating, which was applied following the application of the embroidery. In this case, the embroidery as well as the carrier may be configured to be electrically insulating on the surface, and they may become conductive structures only upon coating.

The basic structure may be formed of an electrically insulating material. For this, there may be named plastic materials, natural materials, and textiles etc. as examples. As a basic material there might be used for a non-conductive carrier also a non-woven PVA-fabric, cellulose acetate or a mixture thereof. In one embodiment variant there may be provided that parts of the carrier are removed following the application of the embroidery, for example, by way of stripping, disintegration, sand blasting etc. Such cases are also called air embroidery. For example, a cotton fabric may be removed by way of acid treatment, cellulose acetate by way of disintegration in acetone or a polyvinyl alcohol non-woven fabric by way of disintegration in hot water.

In the simplest embodiment variant there is provided that the embroidery consists of a material that is electrically conductive at least at the surface thereof. In this case, there may also be embroidered an electrical conductor (e.g., an electric wire) into the carrier.

Other variants provide that the embroidery is configured to be electrically insulating at the surface thereof and that it is made electrically conductive following the post-application of a coating. In embodiment variants there may be provided that the embroidery is composed of metal fibres, film strips, wires, carbon fibres, fibres—preferably plastic fibres or staple fibres—, which optionally also have an electrically conductive coating, or of a combination thereof.

For the sake of convenience, the basic material, of which the embroidery consists, is in the following referred to as a filament, regardless of whether it is a fibre, a wire, a string, a band, and so on. Staple fibres made of conductive materials and conductive coated filaments may be mentioned as electrically conductive filament materials. In a preferred embodiment, metal filaments are used for forming the conductive structures, in an especially preferred embodiment there are used filaments made of carbon fibres, Al, Cu, Ag, Ni, Cr, Pt, Fe and alloys thereof, e.g., stainless steel. Especially suitable as wires or staple fibres, respectively, are materials, which may be processed by way of conventional embroidery.

In a preferred embodiment variant there is provided that the filament, from which the embroidery is made, also has a connecting lug for a conductor. This means that it may be omitted to solder a connecting lug onto the filament. The filament is folded and configured in a region—in particular of the embroidery—in a way so that there is formed a connecting lug, at which a conductor for the remaining galvanic cell is connected.

In a further embodiment variant there may be provided that the conductor density at the surface of the electrode is distributed over the length and width as well as depth of the electrode so that there may be achieved a homogenous current density in the operational status. By means of embroidery, the electrode area is adapted in a way so that the current density distribution is optimized, e.g., by variation of the stitching number and/or the stitch density and/or by different distribution of the filaments in the electrode depth, so that there is achieved a selective homogenization of the current supply. The (uniform) current density distribution may be examined by way of the electrochemically realized conversion at the electrode side. Optionally, this may be confirmed by selective measurement of the current density distribution in the electrode itself.

The electrodes according to the invention may practically be used in galvanic cells of all types. There may be used also fuel cells apart from primary cells (e.g. batteries), secondary cells (e.g., accumulators).

Accordingly, there is provided in one aspect of the invention that the galvanic cell is a primary cell, a secondary cell or a fuel cell.

It has been proven advantageous for a fuel cell, if at least one catalytically active material has been used on the electrically conductive surface, preferably by the Soutache technique.

In one aspect of the invention this also relates to a method for the production of an electrode and a galvanic cell. From the above mentioned feature profiles there may be derived the appropriate method steps.

Further details and advantages of the invention as well as embodiment variants are explained in the following.

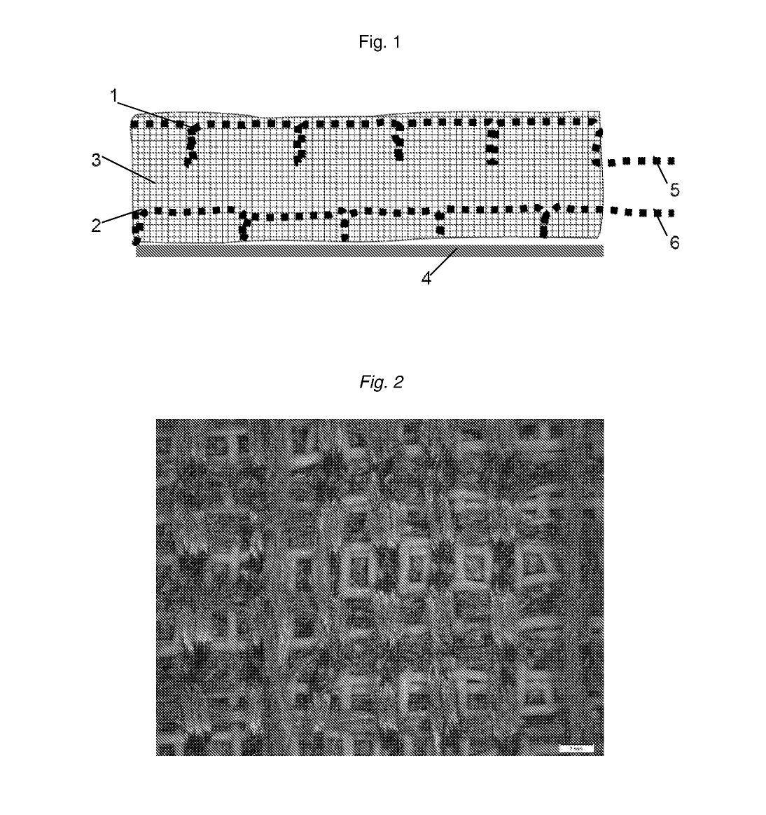

FIG. 1 shows a schematic illustration of an electrode according to the invention.

FIGS. 2 to 4 show three embodiment variants for electrodes according to the invention.

In order to optimize the performance capacity of a battery there is required an optimized current distribution in the active mass in order to enable an optimal utilization of the active mass in the case of high current density.

FIG. 1 schematically shows an exemplary embodiment of the invention in a sectional view. There is shown the carrier 3, which represents a porous textile basic material and which forms a matrix for the embroidery. In the present case there may be seen two embroideries 1, 2, which were embroidered from a conductive material into the carrier 3. The exemplary embodiment depicted shows that each of the two electrically conductive embroideries has a discharge electrode 5, 6. In the present illustration the two embroideries 1, 2 are operated separately, which is why herein there is represented an embodiment as a multi-cathode cell. In this way, this is a multi-electrode. In another embodiment, the two discharge electrodes 5 and 6 are commonly operated and electrically connected, so that this would constitute a single cell. The discharge electrodes 5, 6 may also be configured as a connecting lug for a conductor. In a galvanic cell, the upper side faces the counter-electrode. At the bottom side of the electrode there is situated the back wall 4 of the electrochemical cell.

Filaments made of a conductive or a non-conductive material are attached to a carrier by way of embroidery, so that there is formed a three-dimensional and electrically conductive structure, which is suitable as an electrode for electrochemical applications or current distributor or filaments or wires, respectively. Surprisingly, the technique of embroidery is especially suitable for the production of conductive three-dimensional electrode structures for electrochemical applications. By using technical embroidery, there may be produced conductive structures as current distributors for electrochemical methods.

For the production of the three-dimensional electrode structure there are combined conductive materials and non-conductive elements in a way so that the required density of current distributing conductor paths is achieved in the area of the electrode. In an especially advantageous embodiment an electrode is embroidered as a motif from a conductive filament so that no conductive open filament ends remain in the active part of the electrode so that there is given a substantially lower risk of internal short circuits. The conductive elements of the electrode structure may be led out of the electrode and, hence, simultaneously be used for contacting. In a particular embodiment the density of current distributing conductor elements changes over the length of the electrode with increasing distance from the contacting in order to guarantee a homogenous current distribution over the length of the electrode.

The embroidered electrode structure assumes the function of current distribution in the active mass of the galvanic element. The technical specification of the configuration of electrode material, conductor density and thickness of the 3D structure is dependent on the electrochemically active filler mass used, and it is calculated according to the specifications for three-dimensional porous electrodes. The advantages of using an embroidered electrode structure having a large electrode surface area may be directly determined in measurements for the determination of the current density that may achieved with the electrode potential given. The current density describes the current that may be obtained—in relation to a determined surface area of the electrode. The geometrical area (projected surface; surface area in relation to dimension) of the electrode is usually used as a reference value for the calculation of the current density, as the effective (internal; actual) surface area of the material in particular of three-dimensional electrodes is not easy to be defined. Electrodes having a large internal surface area (e.g., three-dimensional electrodes, Clark-type electrodes, non-woven fabrics, fabric electrodes or embroidered electrodes), hence, in measurements for the determination of current density have correspondingly higher current densities due to their increased internal surface area, in regard to the geometric surface.

In the examples of use voltammograms at planar metal electrodes are compared with voltammograms at embroidered electrodes. For this reason, the solution of a reversible redox system passes an electrode, the potential of which is increased in regard to a reference electrode incrementally to negative values. When the electrode potential reaches the level of the redox potential, a current characteristic for the redox pair will start to flow. Under diffusion-controlled conditions, the level of the current density that may be obtained at the maximum is dependent on the concentration of the redox pair. Whereas in a planar metal electrode the geometrical surface defines the current density that may be obtained at the maximum at the given electrode potential, there are to be expected higher levels with three-dimensional electrodes. From the current density that is obtained in comparable experimental conditions, hence, the performance capacity of an electrode construction may be derived.

### EXAMPLES OF USE

For the examples of use, there were chosen different electrode variants according to the invention.

### Electrode Variant A

### FIG. 2

Construction of the cathode: stainless steel wire (Nm 22/2 steel fibre filament, DIN 14401), embroidered onto stainless steel non-woven fabric at intervals of 2 mm, a further embroidered row being offset between the stitch rows in a distance of 1 mm and embroidered onto the front offset by 1 mm through a PES mesh distance fabric. The material was produced on a Cu/Ni 3015 coated polyester non-woven fabric as basic material.

### Electrode Variant B

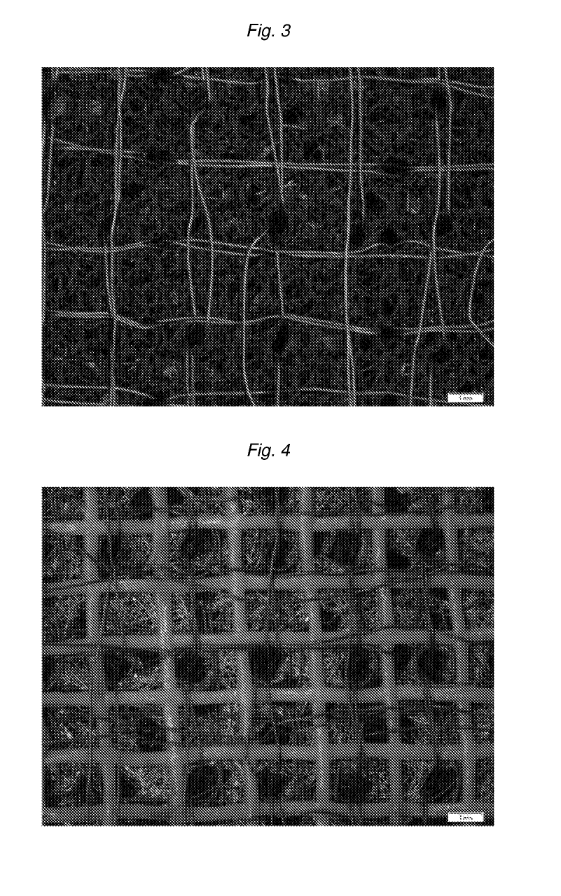

### FIG. 3

The electrode variant B is configured analogously to the electrode variant A; there was, however, used Cu-wire instead of the stainless steel wire.

### Electrode Variant C

### FIG. 4

The electrode variant C is configured analogously to the electrode variant B; there was, however, used a Cu-wire in higher stitch density.

### Example of Use 1

The experiments were carried out at room temperature. The voltammograms were carried out in a flow cell having a parallel geometry. Catolyte and anolyte are separated by a cation exchange membrane (of the Nafion type). As a cathode, there was used for comparative reasons a planar Cu-cathode having an area of 100 cm² (Cu-film, Merck, Darmstadt, Germany), in the examples of use there was used the three-dimensional electrode having the same surface area (electrode variants A to C, see above) that was produced by embroidery. The anode is made of stainless steel.

The test solution is used as a catolyte and pumped through the cathode space by means of a hose pump (flow rate 150 ml/min), corresponding to a catolyte flow rate of about 0.15 cm s⁻¹. The total volume of the catolyte solution amounted to 800 ml. 400 ml 1 M NaOH were used for filling up the anode space. In the catolyte there was used 0.1 M NaOH as a basic catolyte. The cell voltage is either adjusted manually by controlling a laboratory current supply or controlled by a potentiostat so that a desired cathode potential is obtained. The cathode potential is measured in regard to an (Ag/AgCl, 3M KCl) reference electrode. In the case of manual control, there is used a potentiometer (Metrohm pH meter 654, company Metrohm, Herisau, Switzerland), when using the potentiostat, this will assume the function of potential measurement and control. By measuring the cell current as a function of the incrementally changing cathode potential, there is measured a voltammogram.

A detailed description of the cell arrangement is found in the literature (Bechtold T., Turcanu A., Schrott W., “Electrochemical reduction of CI Sulfur Black 1—Correlation between electrochemical parameters and colour depth in exhaust dyeing”, J. Appl. Electrochem., 38 (2008) 25-30; A. Turcanu, T. Bechtold, Indirect cathodic reduction of dispersed indigo by 1,2-dihydroxy-9,10-anthraquinone-3-sulphonate (Alizarin Red S), Journal of Solid State Electrochemistry, 15/9, (2011) 1875-1884. Turcanu A., Fitz-Binder C, Bechtold T., Indirect cathodic reduction of dispersed CI Vat Blue 1 (indigo) by dihydroxy-9,10-anthraquinones in cyclic voltammetry experiments, Journal of Electroanalytical Chemistry, 654/1-2, (2011) 29-37). As an electrochemically reversible redox system there is used a solution of 0.005 mol/l anthraquinone-1,5-disulphonic acid. The voltammograms are recorded at different voltage feed rates v. In both types of electrodes, the cell current amperage is represented at a cathode potential of −800 mV and −900 mV in table 1.

TABLE 1
(GE = basic electrolyte)

| | | current density | | | | | | | |
|---|---|---|---|---|---|---|---|---|---|
| cathode | | mA/cm² | | mA/cm² | | mA/cm² | | mA/cm² | |
| potential | v | embr. electrode | mA/cm² | embr. electrode | mA/cm² | embr. electrode | mA/cm² | Cu-electrode | mA/cm² |
| mV | mV/s | (variant A) | GE | (variant B) | GE | (variant C) | GE | (plate) | GE |
| −800 | 1 | 0.50 | 0.28 | 0.76 | 0.17 | 1.05 | 0.17 | 0.32 | 0.10 |
| | 5 | 0.60 | 0.34 | 0.92 | 0.21 | 1.15 | 0.42 | 0.52 | 0.23 |
| | 10 | 0.91 | 0.50 | 0.99 | 0.27 | 1.13 | 0.60 | 0.52 | 0.23 |
| −900 | 1 | 0.58 | 0.35 | 0.91 | 0.19 | 1.42 | 0.29 | 0.33 | 0.09 |
| | 5 | 0.93 | 0.39 | 1.01 | 0.24 | 1.75 | 0.5 | 0.42 | 0.16 |
| | 10 | 1.20 | 0.52 | 1.18 | 0.25 | 1.82 | 0.62 | 0.49 | 0.16 |
| −1000 | 1 | 0.52 | 0.27 | 1.02 | 0.24 | 1.55 | 0.38 | 0.36 | 0.09 |
| | 5 | 0.97 | 0.41 | 1.13 | 0.29 | 1.96 | 0.56 | 0.46 | 0.14 |
| | 10 | 1.48 | 0.56 | 1.23 | 0.31 | 2.24 | 0.67 | 0.50 | 0.16 |

With the embroidered stainless steel electrode (electrode variant A), there is observed a current density increased by the factor 2 in comparison with the Cu-plate, with the embroidered Cu-electrode there is observed an extraordinarily high current density in spite of the very little surface area of the wire according to construction (electrode variant B or C), which is below the massive Cu-plate electrode by a factor 2-4. The electrode variant B is particularly interesting, if especially expensive materials such as, e.g., Pt, or catalytically active alloys have to be economically used.

### Example of Use 2

The experiments were carried out a room temperature. The voltammograms were carried out in a flow cell having parallel geometry. Catolyte and anolyte are separated by a cation exchange membrane (of the Nafion type). As a cathode, there was used for comparative reasons a planar Cu-cathode having an area of 100 cm² (Cu-film, Merck, Darmstadt, Germany), in the examples of use there was used the three-dimensional electrode having the same surface area (electrode variants A to C, see above) that was produced by embroidery. The anode is made of stainless steel.

The test solution is used as a catolyte and pumped through the cathode space by means of a hose pump (flow rate 150 ml/min), corresponding to a catolyte flow rate of about 0.15 cm s⁻¹. The total volume of the catolyte solution amounted to 800 ml. 400 ml 1 M NaOH were used for filling up the anode space. In the catolyte there was used 0.1 M NaOH as a basic catolyte. The cell voltage is either adjusted manually by controlling a laboratory current supply or controlled by a potentiostat so that a desired cathode potential is obtained. The cathode potential is measured in regard to an (Ag/AgCl, 3M KCl) reference electrode. In the case of manual control, there is used a potentiometer (Metrohm pH meter 654, company Metrohm, Herisau, Switzerland), when using the potentiostat, this will assume the function of potential measurement and control. By measuring the cell current as a function of the incrementally changing cathode potential, there is measured a voltammogram. As an electrochemically reversible redox system there is used a solution of 0.005 mol/l 1,2-dihydroxy-9,10-anthraquinone-3-sulfonate (Alizarin S). In both types of electrodes, the cell current amperage is determined at a cathode potential of −800 mV, −900 mV and −1000 mV and represented in tables 2 and 3. Table 2 shows comparative data between the reference electrode and the electrode variant A in the case of manual measurement (without potentiostat) until a stable signal was obtained. Table 3 shows examinations of the electrode variants B and C with potentiostat. The data of table 2 more or less correspond to a voltage feed rate of 5 mV/s.

TABLE 2
(GE = basic electrolyte)

| | current density | | | |
|---|---|---|---|---|
| cathode | mA/cm² | | mA/cm² | |
| potential | embr. electrode | mA/cm² | Cu-electrode | mA/cm² |
| mV | (variant A) | GE | (plate) | GE |
| −800 | 0.15 | 0.04 | 0.09 | 0.08 |
| −900 | 0.35 | 0.07 | 0.19 | 0.08 |
| −1000 | 0.44 | 0.11 | 0.23 | 0.09 |

TABLE 3
(GE = basic electrolyte)

| | | mA/cm² | | mA/cm² | |
|---|---|---|---|---|---|
| cathode | | embr. electrode | | embr. electrode | |
| potential | v | (variant B) | mA/cm² | (variant C) | mA/cm² |
| mV | mV/s | Cu | GE | Cu | GE |
| −800 | 1 | 0.63 | 0.10 | 0.33 | 0.50 |
| | 5 | 0.69 | 0.25 | 0.42 | 0.47 |
| | 10 | 0.68 | 0.36 | 0.43 | 0.55 |
| −900 | 1 | 0.85 | 0.18 | 0.85 | 0.47 |
| | 5 | 1.05 | 0.30 | 0.96 | 0.43 |
| | 10 | 1.09 | 0.37 | 1.05 | 0.53 |
| −1000 | 1 | 0.93 | 0.23 | 1.45 | 0.59 |
| | 5 | 1.19 | 0.34 | 1.61 | 0.48 |
| | 10 | 1.34 | 0.40 | 1.73 | 0.60 |

In the embroidered stainless steel electrode (variant A) there is observed in comparison with the Cu-plate a current density increased by the factor 2, in the embroidered Cu-electrode there is observed, according to construction (variants B or C), in spite of the low electrode surface of the wire a high current density, which is above the massive Cu-plate electrode by a factor 2-4. The variant B is in particular interesting if especially expensive materials like, e.g., Pt or catalytically active alloys are to be economically used.

1-19. (canceled)

20. An electrode for a galvanic cell, comprising
a carrier provided with embroidery,
wherein at least a part of the surface of the embroidery is configured to be electrically conductive.

21. An electrode according to claim 20, further comprising at least two different types of carriers.

22. An electrode according to claim 20, wherein the carrier comprises a non-woven fabric, a film, a fabric, a mesh or a mixture thereof.

23. An electrode according to claim 20, wherein the carrier is configured to be at least in part electrically insulating.

24. An electrode according to claim 20, wherein the carrier is configured to be at least in part electrically conductive.

25. An electrode according to claim 21, wherein at least one type of carrier is configured to be at least in part electrically conductive and at least one type of carrier is configured to be electrically insulating.

26. An electrode according to claim 20, wherein the carrier is removed in part following the application of the embroidery.

27. An electrode according to claim 20, wherein the carrier and the embroidery are provided with an electrically conductive coating, which was applied following the application of the embroidery onto the carrier.

28. An electrode according to claim 20, wherein the embroidery includes a material that is electrically conductive at least on the surface thereof.

29. An electrode according to claim 20, characterized in that the embroidery is applied by means of the Soutache technique.

30. An electrode according to claim 20, wherein the embroidery includes metal fibres, film strips, wires, carbon fibres, fibres, plastic fibres or staple fibres or of a combination thereof.

31. An electrode according to claim 20, wherein the filament, from which the embroidery is made, includes a connection lug for a conductor.

32. An electrode according to claim 20, wherein the conductor density of the electrode is distributed over the length, width and depth of the electrode so that there may be achieved a homogenous current density distribution in the operative status.

33. An electrode according to claim 20, wherein catalytically active materials on the electrically conductive surface have been used.

34. A galvanic cell including two electrodes, which are each embedded in an electrolyte, wherein at least one electrode is configured according to claim 20.

35. A galvanic cell according to claim 34, wherein the electrode is embedded in an electrochemically active mass.

36. A galvanic cell according to claim 34, wherein said galvanic cell is a fuel cell, wherein catalytically active materials on the electrically conductive surface of the electrode have been consumed.

37. A half-cell including an electrode, which is embedded in an electrolyte, wherein at least one electrode is configured according to claim 20.
